(19) United States
(12) Patent Application Publication
(10) Pub. No.: US 2012/0009341 A1
(43) Pub. Date: Jan. 12, 2012

(54) METHOD FOR MODIFYING THE SURFACE OF A BIOINERT MATERIAL

(75) Inventors: Jun Hong Noh, Seoul (KR); Dong Wook Kim, Gyeonggi-do (KR); Jae Sul An, Seoul (KR); Hae Rin Chang, Seoul (KR); Dong Hoe Kim, Gyeonggi-do (KR); Kug Sun Hong, Seoul (KR); Dong Kyu Chin, Gyeonggi-do (KR)

(73) Assignee: SNU R&DB FOUNDATION, Seoul (KR)

(21) Appl. No.: 13/148,795

(22) PCT Filed: Jan. 22, 2010
(86) PCT No.: PCT/KR2010/000410

§ 371 Date: Sep. 29, 2011

(30) Foreign Application Priority Data
Feb. 12, 2009 (KR) 10-2009-0011479

(51) Int. Cl. B05D 5/00; B05D 3/02; B05D 3/10; B05D 1/12

(52) U.S. Cl. 427/180

(57) ABSTRACT

Provided is a method for modifying the surface of a bioinert material, the method including preparing a base material composed of a bioinert material; and spraying a bioactive powder onto the bioinert base material through a spray nozzle using a high pressure carrier gas to form a bioactive layer on the base material. The surface modification method enables mass production, at low cost, of new biomaterials having the advantages of both a coating substance and a body to be coated, by applying a bioactive material to various bodies to be coated through a cold spray method.

### BACKGROUND OF THE INVENTION

1. Field of the Invention

The present invention relates to a surface modification method for a bioinert material, and more particularly, to a method for modifying the surface of a bioinert material, which can enhance the bioactive ability possessed by a calcium phosphate compound, a bioglass or the like, while maintaining the inherent characteristics of a metal or a polymeric biomaterial as intact as possible, and which is advantageous in mass production of biomaterials.

2. Description of the Related Art

Kitsugi and colleagues have reported that when calcium phosphate compounds such as hydroxyapatite (HA, Ca₁₀(PO₄)₆(OH)₂), tricalcium phosphate (TCP, Ca₃(PO₄)₂), tetracalcium phosphate (TTCP, Ca₄P₂O₉), and calcium pyrophosphate (CPP, Ca₂P₂O₇) are implanted into the bone tissue of a rabbit, and the interfaces are observed, the implants all formed direct chemical bonding with the bone tissue at the interfaces (Biomaterials, 16, 1101-1107 (1995)).

Calcium phosphate compounds all have in common the property of forming direct bonding with the bone tissue, but hydroxyapatite which is the most analogous to the inorganic substance constituting the bones of our body, has been extensively studied as an artificial bone material for implantation. Hydroxyapatite has advantages such as excellent biocompatibility and good compression strength with no problem of erosion, but also has disadvantages such as high brittleness, which is intrinsic to ceramics, and poor ductility, so that production of fixing devices or products of various shapes using hydroxyapatite is difficult.

Bioglasses, which contain CaO, SiO₂ and P₂O₅ as principal components and MgO, CaF₂, B₂O₃, Na₂O₃, K₂O₃, SrO and the like as additives, are glasses or crystallized glasses containing large amounts of calcium oxide and phosphate, and likewise exhibit bioactive properties. However, such bioglasses also have limitations in use because of their low strength.

Because the ceramics and glasses described above have weak mechanical properties, despite their excellent bioaffinity, it is the current situation that metallic materials such as stainless steel, cobalt-chromium alloys and titanium alloys, which have excellent mechanical strength, are primarily used as the biomaterials which require high mechanical properties.

Thus, many researchers have made various attempts to coat the surfaces of metallic materials with calcium phosphate compounds or bioglasses, in order to impart the bioactive properties that are absent in metallic materials. The coating methods that have been hitherto used mainly include a sol coating method, a plasma thermal spraying method, a sputtering method, and the like. However, these coating processes should be carried out at high temperatures in order to achieve appropriate crystallization or densification of the calcium phosphate compounds and to obtain an appropriate bonding strength, and the coating processes have a problem that the metals constituting the base material become oxidized under high temperatures. The sol coating method essentially requires a heat treatment for crystallization after coating, and this heat treatment brings about the problem of oxidation of metals. In the plasma thermal spraying method, phase transition of ceramics occurs under the action of high temperature plasma, and thereby substances that are easily absorbed in the living body are generated. As a result, a non-uniform coating layer is produced. Furthermore, in the case of using expensive vacuum equipment such as a sputtering apparatus, there may occur a problem of increased production cost of the material, and the necessity of low temperature processes has been raised as an issue in view of mass production.

Another problem is that when a metallic material is used in artificial bones, the difference in strength between the metallic material and the real bone is so large that a so-called “stress shielding” phenomenon occurs in which stress transfer occurs only to the metal, and stress distribution to the bone material does not occur, causing a decrease in the strength of the bone material. Also, secondary surgeries for removal are additionally needed after healing, and the problem of erosion of the metal also restricts the use of metallic materials.

In order to overcome such disadvantages of metals and ceramic materials as described above, various polymeric biomaterials have been recently developed. Unlike the metals or ceramic materials, polymeric materials have various compositions and excellent processability, and have an advantage that the materials can be easily fabricated into various shapes.

Polymeric biomaterials can be largely classified into non-degradable polymeric materials and biodegradable polymeric materials, and a large number of polymeric materials as exemplified in Table 1 have been developed and used according to the required mechanical properties. Among these, particular attention is paid to biodegradable polymeric materials such as polyglutamic acid (PGA) and polylactic acid (PLA), which do not erode after surgery but are degraded by themselves so that secondary surgeries are not necessary, and which are gradually degraded and do not deteriorate the strength of bones so that there is no problem of stress shielding.

TABLE 1
Examples of polymeric biomaterials
Material

Silicon Rubber (SR)
Polyethylene (PE)
Polyurethane (PU)
Polyglutamic acid (PGA)
Polylactic acid (PLA)
Polycaprolactone (PCL)
Polydioxanone (PDO)
Polyterafluoroethylene (PTFE)
Polymethyl methacrylate (PMMA)
Polyethylene threphthalate (PET)
Polyether ether ketone (PEEK)

The problem of low mechanical strength, which is the most significant disadvantage of polymeric biomaterials, have been greatly enhanced as a result of the recent production of various composites. However, in the case of polymeric biomaterials, the bioactive properties exhibited in ceramic materials such as calcium phosphate compounds cannot be expected. Therefore, in order to enhance biocompatibility and the osteointegration ability, attention has been focused on the necessity of compositization of polymeric biomaterials and calcium phosphate ceramic materials.

In biomaterials, the biocompatibility and osteointegration ability are in close relations with surface compatibility, and are characterized by varying depending on the chemical, biological and physiological compatibility between the surfaces of biomaterials and the body tissues, and the degree of conformity of the surface morphology. Accordingly, as described previously, studies have been extensively conducted to enhance biocompatibility, by coating the surfaces of metal implants with calcium phosphate ceramics such as hydroxyapatite, or the like.

Calcium phosphate coating of the surfaces of polymeric biomaterials is also one of the most effective methods to enhance biocompatibility. However, calcium phosphate ceramic coating necessitates a heat treatment at a high temperature in order to induce crystallization of the coating layer, or necessitates a cost-consuming vacuum deposition method for low temperature crystallization. In the case of polymeric biomaterials, a heat treatment at a high temperature bring about deformation of polymers, and such deformation eventually deteriorate the performance of polymers, preventing the polymers from being used as biomaterials. Furthermore, a vacuum deposition method at a low temperature may also damage the surfaces of polymers, causing deformation, and requires high production cost to increase productivity, which is not preferable.

Currently, metals are used in most cases where biomaterials with high mechanical strength are required. To the present, numerous technologies of coating the surfaces of metallic materials with bioactive substances have been developed; however, these technologies also have a problem of the potential to induce oxidation of metals because of the high temperature processes required by ceramic materials. In recent years, development of biopolymers which have mechanical properties that are comparable to those of metals is actively underway, and it is anticipated to develop biomaterials which not only have high mechanical properties to be able to replace metallic materials, but also can address even the problem of “stress shielding,” which is one of the problems of metallic biomaterials.

However, the metallic materials that are currently in use or the polymeric biomaterials that are expected to be useful in many applications in the future, do not themselves have bioactive ability, and therefore, their surfaces need to be modified with bioactive materials. For this purpose, there is a strong demand for the development of a cold coating technology which can address all of the problem of metal oxidation and the problem of thermal deformation of polymers, and is also advantageous in mass production.

In addition, when the specific surface area of a material surface is increased, the area that can be brought into contact with osteocytes is increased, and accordingly, the osteointegration ability can be improved. In order to achieve this, a technology of increasing the roughness of the surface of a coated bioactive layer will also be necessary for the production of biomaterials for bone bonding with high efficiency.

### SUMMARY OF THE INVENTION

The present invention was achieved under such circumstances, and an object of the present invention is to provide a new coating technology which can enhance the bioactive ability possessed by a calcium phosphate compound, a bioglass or the like, while maintaining the inherent characteristics of a metal or a polymeric biomaterial as intact as possible, and which is advantageous in mass production of biomaterials.

According to an aspect of the present invention, there is provided a method for modifying the surface of a bioinert material, the method including the steps of preparing a base material composed of a bioinert material; and spraying a bioactive powder onto the bioinert base material through a spray nozzle using a high pressure carrier gas to form a bioactive layer on the base material.

As described above, according to the method for coating a bioactive compound of the present invention, a polymeric biomaterial which can substitute a metallic material or a ceramic biomaterial and has various advantages but has no bioactive ability, can be imparted with bioactive ability by coating the polymeric biomaterial at a low temperature with a calcium phosphate compound or a bioglass powder, both of which have excellent bioactivity, while maintaining the initial powder characteristics.

Furthermore, the cold spray coating method used in the present invention overcomes the limitations of various conventional coating methods, and enables coating of the surfaces of polymeric biomaterials while maintaining the intrinsic properties of both the powder and the polymer, with low production cost and high productivity.

Therefore, the metal surface coating method according to the present invention, particularly the method for producing a surface-modified biopolymer, is expected to remarkably increase the applicability and industrial usefulness of biocompatible metal and polymeric materials.

### BRIEF DESCRIPTION OF THE DRAWINGS

FIG. 1 is a diagram schematically showing the configuration of the cold spray coating apparatus used in the present invention;

FIG. 2 is a photograph obtained by observing the surface of a PEEK polymeric biomaterial coated with hydroxyapatite according to an embodiment of the present invention, with a scanning electron microscope; and

FIG. 3 is a graph showing the X-ray diffraction analysis results obtained before and after coating of the surface of PEEK coated with hydroxyapatite by cold spraying according to an embodiment of the present invention.

### DETAILED DESCRIPTION OF THE PREFERRED EMBODIMENTS

Hereinafter, preferred embodiments of the present invention will be described in detail.

A cold spray coating process is a new coating technology for forming a coating layer on an object by spraying a powder on the object with an accelerated ultrasonic jet of a compressed gas (He, N₂, air, or a mixed gas thereof). Such a cold spray coating method uses a powder that has been already crystallized or has inherent characteristics, as initial particles, and thereby can maintain the intrinsic properties of the initial particles. Also, since the coating technology utilizes the kinetic energy of the powder, the coating technology has advantages that preheating of the object to be coated can be minimized, low temperature processing is made possible, and high productivity can be expected.

According to the present invention, there is provided a method of coating the surface of a metallic or polymeric biomaterial by such a cold spray coating technology, using a powder having bioactive ability such as a calcium phosphate compound or a bioglass at a low temperature, in order to form a bioactive layer on the metallic or polymeric biomaterial, without performing a post-annealing process at a high temperature.

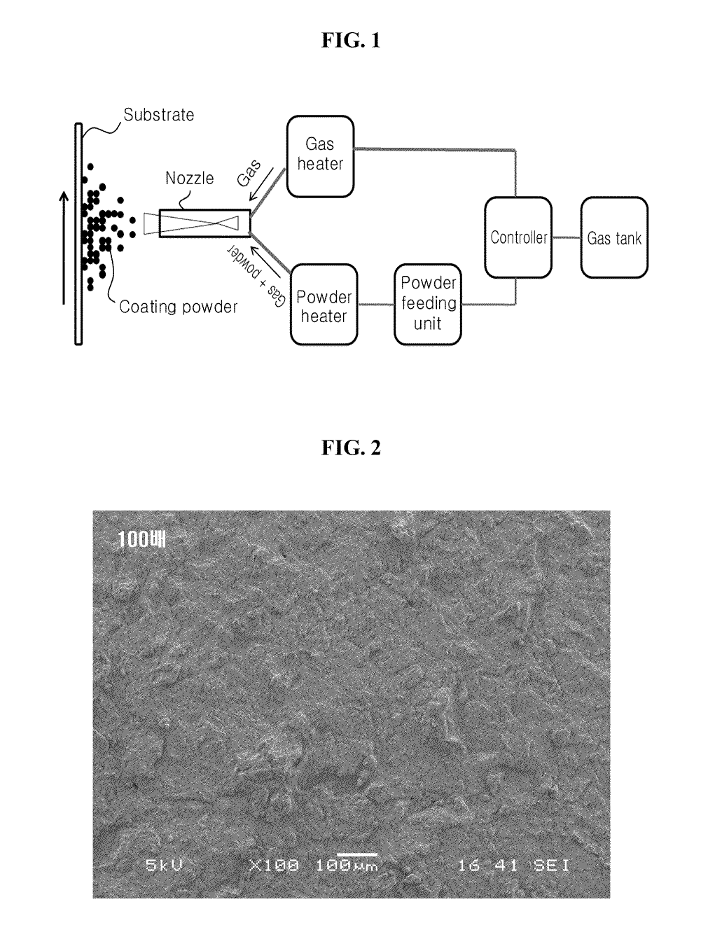

FIG. 1 schematically shows an example of the cold spray coating apparatus used in the present invention. The cold spray coating of the present invention can be performed using the cold spray coating machine depicted in FIG. 1.

Such a cold spray coating machine includes a gas tank, a controller, a gas heater, a powder feeding unit, a powder heater, and a nozzle. A gas supplied from the gas tank is sent via the controller to the gas heater and the powder feeding unit. In the gas heater, the pressure of the gas is increased by heating the gas, and thereby acceleration of the velocity of the gas is induced. In the powder feeding unit, a powder is supplied to the gas sent from the controller, and in the powder heater, the powder is heated. A high temperature gas and a gas-powder mixture are brought into contact at the nozzle, and the mixture is spray through the nozzle as a high-speed gas-powder jet stream.

The powder in the jet stream thus sprayed has high kinetic energy and collides with the surface of an object to be coated (substrate), thereby binding with the object and forming a coating layer thereon. Thereafter, the object to be coated is transported simultaneously with the formation of the coating layer, and is cooled.

Examples of the bioactive powder that can be used in the present invention include calcium phosphate compounds such as hydroxyapatite (HA); bioglass compounds such as bioglasses containing CaO, SiO₂ and P₂O₅ as main ingredients, and crystallized bioglasses; and mixtures thereof. Examples of the bioinert base material include, as metallic materials, stainless steel, Co—Cr alloys and Ti alloys; as polymeric materials, the materials indicated in Table 1 shown above, non-degradable or biodegradable polymer materials, and mixtures thereof; and as materials different from the polymeric materials, composites of metallic materials such as stainless steel, Co—Cr alloys and Ti alloys, with ceramic materials such as Al₂O₃, MgO and SiO₂. Preferred examples include PEEK and PEEK composites.

Since a calcium phosphate compound powder or a bioglass powder hardly has any ductility compared with metal powders, it may be difficult to form a high density coating layer of the calcium phosphate compound powder or the bioglass powder on an object. In this case, the lamination density can be increased by, for example, mixing a small portion of a metal powder or a polymer powder with the initial powder and spraying the mixture. Examples of the metal powder that can be used for this purpose include powders of stainless steel, titanium, and a Co—Cr alloy. Examples of the polymer powder include powders of non-degradable polymeric materials and biodegradable polymeric materials.

The ratio of the bioactive powder and the metal powder in the mixture may be 20:1 to 1:1 by volume. If the volume ratio of the bioactive powder and the metal powder is smaller than 20:1, the metal content is insufficient, and a substantial effect of improving the lamination density cannot be expected. If the content of the metal powder exceeds 50%, the final product does not conform to the purpose of the present invention of providing the coating of a bioactive layer.

The ratio of the bioactive powder and the polymer in the mixture may be 1000:1 to 10:1 by volume. In the case of a polymer, the surfaces of the bioactive powder particles can be appropriately coated with the polymer even at a small volume ratio. Coating of a polymer and a bioactive powder can be achieved with a volume ratio of 1000:1 in the mixture, and at a volume ratio smaller than this, large portions of the bioactive powder particles may not be coated with the polymer, so that an effect of improving the lamination density cannot be expected. If the polymer content is higher than 10:1, there is a risk that the polymer may agglomerate the bioactive powder and clog the nozzle.

In the case of a polymeric base material, as an appropriate method for preventing the damage to the polymer surface by the high temperature carrier gas sprayed together with the powder, there is a need to cool the base material. This cooling can be carried out by, for example, controlling the transport speed of the base material to an appropriate range.

Similarly, the temperature of the carrier gas is also maintained in the range of normal temperature to 600° C., for the protection of the base material. Examples of the carrier gas that can be used include, but are not particularly limited to, helium, nitrogen, argon, oxygen, hydrogen, gas mixtures thereof, and air.

However, when a mixture of a bioactive powder and a metal or a polymer is sprayed, it is preferable to exclude oxygen and air from the carrier gas, in order to prevent oxidation of the metal or to prevent degradation of the polymer. However, under the spraying conditions in which the temperature of the gas is set to 300° C. or lower, oxygen and air can be used as the carrier gas.

Meanwhile, when the bioactive powder is sprayed onto the base material, the bioactive powder may be preheated in advance before spraying, for the purpose of increasing the adhesion efficiency. The preheating temperature at this time is set to 600° C. or lower, and particularly in the case of mixing the bioactive powder with a metal powder or a polymer powder, the preheating temperature is set to 300° C. or lower in order to prevent oxidation of the incorporated metal powder and to prevent degradation of the polymer powder.

The size of the powder used to coat the base material is an important factor which greatly affects the adhesiveness of the coating layer formed on the base material. If the powder particle size is small, the mass of the powder particles is decreased, and consequently, the kinetic energy of the powder particles is decreased. Eventually, the powder may not have sufficient energy to allow the powder to adhere to the object to be coated. Furthermore, if a powder having an excessively large particle size is used, the powder particles may not be accelerated by the gas, so that the kinetic energy of the powder particles is decreased, and the powder may have poor adhesiveness. For these reasons, the size of the powder particles used in the present invention is suitably 0.01 to 200 μm, and particularly preferably 1 to 200 μm.

Powder particles having a size of 0.01 to 1 μm are so small that the particles may not have sufficient kinetic energy, and cannot be accelerated to be able to adhere to the object to be coated at the time of cold spraying. However, powder particles having such a small size have an advantage that when the powder particles form a coating layer on the object, the lamination density can be increased. In order to utilize a powder having such advantages with a small particle size in cold spray coating, powder particles having a size of 0.01 to 1 μm are granulated into granules having a size of 1 to 10 μm and sprayed. In this case, since sufficient kinetic energy can be provided to the granules, a bioactive powder coating layer having a high lamination density can be formed with high efficiency.

Since the formation of a gas jet stream and the kinetic energy of the powder are dependent on the temperature and pressure of the carrier gas, these temperature and pressure are parameters important for an improvement of the adhesion characteristics of the powder. In order to form a gas jet stream easily and to secure a constant gas flow rate, it is preferable to increase the temperature and pressure of the carrier gas as much as possible. However, since it is necessary to minimize the oxidation of the metallic base material or the surface damage of the polymeric base material, the temperature of the carrier gas is preferably from normal temperature to 600° C., and more preferably 200 to 600° C., and the pressure is preferably 1 to 50 kg/cm², and more preferably 10 to 15 kg/cm².

The carrier gas used for this purpose is not particularly limited, but it is preferable to use helium, nitrogen, argon, oxygen, hydrogen, a gas mixture thereof, or air. The mass flow rate of the coating particles is preferably in the range of 5 to 40 g/min.

According to the present invention, it is also possible to appropriately preheat the base material during the spraying process according to the purpose. At this time, the preheating temperature of the base material may vary with the type of the polymeric biomaterial, but usually a temperature range which does not damage the polymeric material is preferred. In the case of a metal, a temperature which does not cause oxidation of the metal is preferred. For this purpose, the temperature of the base material is preferably 600° C. or lower, and particularly preferably 300° C. or lower.

On the other hand, the distance between the base material and the spray nozzle is preferably 5 mm to 60 mm. If the distance between the base material and the nozzle is larger than 60 mm, the distance between the base material and the powder sprayed from the nozzle is so large that the kinetic energy of the powder may not be sufficiently transferred to the base material, and the adhesiveness of the powder and the lamination ratio will be decreased. Also, if the distance is less than 5 mm, there may be a problem of gas backflow.

Furthermore, since there is a risk that the polymeric material used as the base material substrate may be damaged as a result of heating with the hot gas sprayed, it is preferable to cool the base material substrate by regulating the transport rate of the base material.

On the other hand, there is a need to increase the surface area of the biomaterial coated with the bioactive layer that reacts with osteocytes, in order to improve the osteointegration ability of the biomaterial. For this purpose, the present invention employs a method of immersing the surface of the formed coating layer in an acid solution to partially dissolve the surface of the coating layer, and thereby increasing the roughness of the coating layer surface.

The acidic solution is preferably an aqueous solution of phosphoric acid (H₃PO₄), hydrochloric acid (HCl), nitric acid (HNO₃), hydrofluoric acid (HF), sulfuric acid (H₂SO₄) or the like, from the viewpoint of being non-toxic to the living body. In the treatment with an acidic solution, the extent of the surface roughness is determined according to the acidity (pH) and the duration of treatment. Thus, in order to partially dissolve the surface of the coating layer, a treatment for a short time is preferred, and since the coating layer is not easily dissolved in the high pH region, for example, it is preferable to immerse the coating layer for 10 to 60 seconds at pH 1 to 2.

### EXAMPLES

Hereinafter, the present invention will be described in more detail by way of Examples. However, the present invention is not intended to be limited to the following Examples.

As the bioinert material used as a base material, polyether ether ketone (PEEK), which is a polymeric biomaterial, was used. As the bioactive powder, a hydroxyapatite powder having an average particle size of 1 to 20 μm and a Ca/P ratio of 1.67 was used. This hydroxyapatite powder was cold sprayed onto the surface of the PEEK base material, and thus a bioactive layer was formed thereon.

At this time, an apparatus as depicted in FIG. 1 was used as the cold spray coating apparatus, and air was used as the carrier gas. The temperature of the gas used was controlled to 500° C., and the pressure was set to 20 kg/cm². The temperature of the bioactive powder and the base material substrate was all adjusted to normal temperature, and the distance between the spray nozzle and the PEEK base material surface was set to 30 mm. The spray flow rate of the coating particles was 10 g/min, and the transport speed of the substrate was 1 cm/sec.

FIG. 2 is a scanning electron microscopic (SEM) photograph showing the PEEK surface coated with HA according to the embodiment of the present invention, at a magnification of 100 times. It can be seen from this photograph that hydroxyapatite has been evenly coated over the entire surface without any particularly large powder particles, and there is no damage to the PEEK surface.

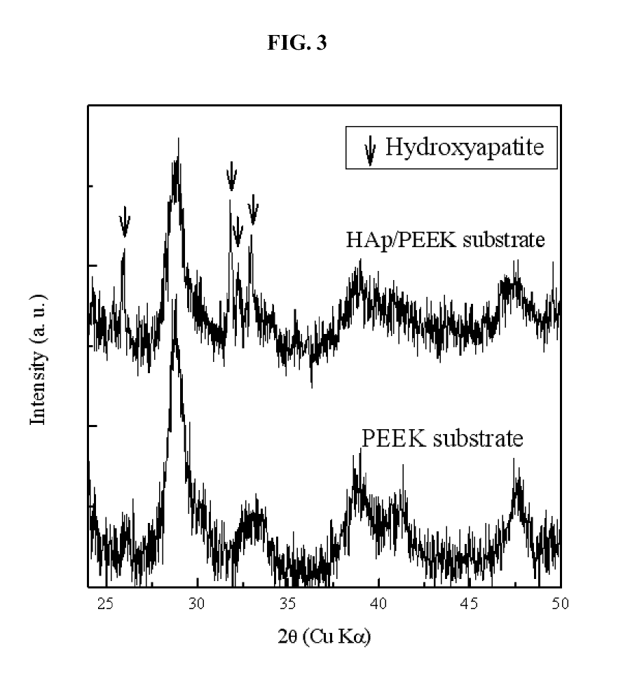

FIG. 3 shows the results of X-ray diffraction spectroscopy of the PEEK surface obtained before and after the HA coating according to the present invention. It can be seen that no HA peaks are observed for the PEEK surface before coating, but peaks of satisfactory crystalline phase HA are observed for the coated PEEK surface.

Therefore, it was found that according to the present invention, a polymeric biomaterial can be coated on the surface with a calcium phosphate compound with satisfactory crystallinity, without carrying out a post-annealing process and without damaging the surface of the polymeric biomaterial. Furthermore, surface modification of increasing the surface area can be achieved by controlling the surface roughness through an acidic solution treatment of the coating layer.

### INDUSTRIAL APPLICABILITY

The present invention can enhance the bioactive ability possessed by a calcium phosphate compound, a bioglass or the like, while maintaining the inherent characteristics of a metal or a polymeric biomaterial as intact as possible. Also, the present invention can modify the surface of a bioinert material so that mass production can be advantageously achieved. Thus, the present invention can be applied to various industrial fields such as the applications of metallic and polymeric biomaterials, and artificial bones.

1. A method for modifying the surface of a bioinert material, the method comprising:
preparing a base material composed of a bioinert material; and
spraying a bioactive powder onto the bioinert base material through a spray nozzle using a high pressure carrier gas to form a bioactive layer on the base material.

2. The method for modifying the surface of a bioinert material according to claim 1, wherein the bioactive powder contains at least one selected from a calcium phosphate compound and a bioglass compound.

3. The method for modifying the surface of a bioinert material according to claim 2, wherein the calcium phosphate compound is at least one selected from hydroxyapatite, tricalcium phosphate (TCP), tetracalcium phosphate (TTCP), and calcium pyrophosphate.

4. The method for modifying the surface of a bioinert material according to claim 2, wherein the bioglass compound is a bioglass or crystallized bioglass containing CaO, SiO₂ and P₂O₅ as main ingredients.

5. The method for modifying the surface of a bioinert material according to claim 1, wherein the bioinert base material is any one selected from stainless steel, a Co—Cr alloy and a Ti alloy

6. The method for modifying the surface of a bioinert material according to claim 1, wherein the bioinert base material is a non-degradable or biodegradable single polymer material, a mixture of such polymers, or a composite of a metal or ceramic material with the polymer material.

7. The method for modifying the surface of a bioinert material according to claim 1, wherein the bioinert base material is polyether ether ketone (PEEK) or a PEEK composite.

8. The method for modifying the surface of a bioinert material according to claim 1, wherein the bioactive powder has a particle size in the range of 0.01 to 200 μm.

9. The method for modifying the surface of a bioinert material according to claim 8, wherein when the particle size of the bioactive powder is 0.01 to 1 μm, the powder is granulated into granules and then sprayed.

10. The method for modifying the surface of a bioinert material according to claim 1, wherein the bioactive powder is mixed with at least one of a metal powder and a polymer powder.

11. The method for modifying the surface of a bioinert material according to claim 10, wherein the metal powder includes at least one of stainless steel, titanium, and a Co—Cr alloy.

12. The method for modifying the surface of a bioinert material according to claim 11, wherein the volume ratio of the bioactive powder and the metal powder is 20:1 to 1:1.

13. The method for modifying the surface of a bioinert material according to claim 10, wherein the polymer powder contains a non-degradable polymeric material or a biodegradable polymeric material.

14. The method for modifying the surface of a bioinert material according to claim 13, wherein the volume ratio of the bioactive powder and the polymer is 1000:1 to 10:1.

15. The method for modifying the surface of a bioinert material according to claim 1, wherein the bioinert base material is preheated at a temperature of 600° C. or lower.

16. The method for modifying the surface of a bioinert material according to claim 1, wherein the temperature of the carrier gas is from normal temperature to 600° C.

17. The method for modifying the surface of a bioinert material according to claim 10, wherein when the bioactive powder mixed with a metal powder or a polymer powder is sprayed, the carrier gas is preheated to a temperature of 300° C. or lower.

18. The method for modifying the surface of a bioinert material according to claim 1, wherein the carrier gas is helium, nitrogen, argon, oxygen, hydrogen, a gas mixture thereof, or air.

19. The method for modifying the surface of a bioinert material according to claim 1, wherein the spray pressure of the carrier gas is 1 to 50 kg/cm².

20. The method for modifying the surface of a bioinert material according to claim 1, wherein the bioactive powder is preheated to a temperature of 600° C. or lower before spraying.

21. The method for modifying the surface of a bioinert material according to claim 10, wherein the bioactive powder mixed with a metal powder or a polymer powder is preheated to a temperature of 300° C. or lower before being sprayed.

22. The method for modifying the surface of a bioinert material according to claim 1, wherein the distance between the spray nozzle and the base material is 5 to 60 mm.

23. The method for modifying the surface of a bioinert material according to claim 1, further comprising immersing the bioactive layer formed on the surface of the base material in an acidic solution, and thereby increasing the specific surface area of the bioactive layer.

24. The method for modifying the surface of a bioinert material according to claim 23, wherein the acidic solution is at least one selected from phosphoric acid, hydrochloric acid, nitric acid, hydrofluoric acid, and sulfuric acid.

25. The method for modifying the surface of a bioinert material according to claim 6, wherein the bioinert base material is polyether ether ketone (PEEK) or a PEEK composite.

26. The method for modifying the surface of a bioinert material according to claim 2, wherein the bioactive powder has a particle size in the range of 0.01 to 200 μm.

27. The method for modifying the surface of a bioinert material according to claim 26, wherein when the particle size of the bioactive powder is 0.01 to 1 μm, the powder is granulated into granules and then sprayed.

28. The method for modifying the surface of a bioinert material according to claim 16, wherein the carrier gas is helium, nitrogen, argon, oxygen, hydrogen, a gas mixture thereof, or air.
